(19) United States
(12) Patent Application Publication
(10) Pub. No.: US 2017/0066202 A1
(43) Pub. Date: Mar. 9, 2017

(54) COMPOSITE TOOL MOISTURE/WRINKLE BARRIER

(71) Applicant: NORTHROP GRUMMAN SYSTEMS CORPORATION, FALLS CHURCH, VA (US)

(72) Inventors: GLEN A. McBRAYER, TORRANCE, CA (US); JUD J. YAMANE, TORRANCE, CA (US); SUNDEEP K. PURI, REDONDO BEACH, CA (US); BRIAN J. HILL, TORRANCE, CA (US); EDWARD R. ZABIELSKI, HERMOSA BEACH, CA (US); GERARDO HERNANDEZ, WEST COVINA, CA (US); FRANK H. HOREY, NORTHRIDGE, CA (US); SAUL PEREZ, GARDENA, CA (US)

(21) Appl. No.: 14/992,902

(22) Filed: Jan. 11, 2016

Related U.S. Application Data
(60) Provisional application No. 62/214,073, filed on Sep. 3, 2015.

(51) Int. Cl. B29C 70/30; B29C 35/00; B64G 1/54; B29C 70/06; B64G 1/10; B29C 35/02; B29C 70/54

(52) U.S. Cl. CPC B29C 70/30; B29C 35/02; B29C 35/002; B29C 70/54; B29C 70/06; B64G 1/10; B64G 1/54; B29C 2035/005; B29L 2031/3097

(57) ABSTRACT

A method for fabricating a carbon fiber composite part, for example, a sun shield structural assembly on a satellite. The composite part is fabricated on a carbon fiber/bismaleimide (BMI) composite tool, where a moisture barrier is positioned on the tool prior to carbon fiber part ply layers being positioned on the tool to prevent moisture from the tool from entering the part. In one embodiment, the moisture barrier includes cross-wise strips of aluminum foil. A wrinkle barrier is positioned on the moisture barrier before the carbon fiber part ply layers so that anomalies or wrinkles in the moisture barrier are not transferred to the part layers.

### CROSS-REFERENCE TO RELATED APPLICATIONS

This application claims the benefit of the priority date of U.S. Provisional Patent Application Ser. No. 62/214,073, titled, Composite Tool Moisture/Wrinkle Barrier, filed Sep. 3, 2015.

### GOVERNMENT CONTRACT

The U.S. Government may have a paid-up license in this invention and the right in limited circumstances to require the patent owner to license others on reasonable terms as provided for by the terms of Contract No. NAS5-02200 awarded by NASA.

### BACKGROUND

Field

This invention relates generally to a method for fabricating a carbon fiber composite structure and, more particularly, to a method for fabricating a carbon fiber composite structure using a tool, where the method includes providing a moisture barrier adjacent to the tool to reduce moisture flow from the tool to the structure as it is being fabricated and includes providing a wrinkle barrier between the moisture barrier and the structure to prevent wrinkles and other anomalies in the moisture barrier from being transferred to the structure.

Discussion

Many structural parts and components on a satellite or spacecraft need to be light weight and strong in order to meet specific mission requirements. Parts fabricated using carbon fiber composites technologies often meet these requirements. A typical carbon fiber composite part for a spacecraft will often include two opposing face sheets, where each face sheet is formed by a number of carbon fiber ply layers and where a honeycomb structure also formed of the carbon fiber ply layers is provided between the face sheets so that the primary structural integrity of the part is at its outer edges and the honeycomb structure provides the desired stiffness and light weight properties.

One known technique for fabricating some of these parts using carbon fiber composite technologies includes laying down many of the carbon fiber ply layers on a tool, where each ply or sheet of the carbon fiber ply layers includes carbon fibers that have been impregnated with a powder resin, and where the fibers are woven into a fabric or tape. The carbon fiber ply layers are laid on the tool in a continuous stacked manner, where every group of a predetermined number of the ply layers is subjected to a vacuum and heating step to compress the ply layers together and remove air, which otherwise could result in loss of part integrity. Once all of the ply layers have been built up, a vacuum film or bag is placed over the assembled ply layers and sealed to the tool, where the bag is evacuated to a certain vacuum pressure. The tool and sealed part are then placed in an autoclave or heating oven to cure the resin and form the hardened part.

It is essential that during fabrication of polycynate resin composite parts, such as certain spacecraft and flight parts, moisture is prevented from entering the fiber ply layers because moisture is known to reduce the integrity and performance of parts utilizing resin systems. Particularly, even a minimal amount of moisture in the ply layers could cause hydrolysis of cyanate monomers in cyanate ester resins in the carbon fiber ply layers that prevents the primary cross-linking reaction to occur during the curing process, which causes carbamate formation in the carbon fiber ply layers. Because carbamate has different structural and resilient properties than polycyanate, the structural integrity and thermal performance of the part is reduced.

Traditionally, metallic lay-up tools can be used in applications where moisture sensitivity is a concern. Metallic tools do not retain moisture and those made from Invar (a nickel-iron alloy) have a low coefficient of thermal expansion, which ensures that the tool profile growth during elevated curing temperatures is controlled. Bulk graphite tools are also commonly used due to their low coefficient of friction and low moisture absorption properties. Moisture can additionally be controlled on bulk graphite tooling through the application of tool sealers. However, when fabricating large composite parts, as in certain spacecraft structures, traditional tooling concepts may not be practical due to the excessive tool machining time required, the excessive finished weight of the tool and the overall tool production cost. When these factors dictate, non-traditional tooling such as those made from carbon fiber/bismaleimide (BMI) can be used. BMI tooling can be made into billets and then machined down to desired tool profiles at a fraction of the cost and weight. Unfortunately, a less desirable aspect of BMI tooling is that it is known to absorb moisture over time, which can contaminate prepreg composite parts during the fabrication process.

It is known in the art to heat the tool to a certain temperature and for a certain period of time to reduce or eliminate moisture in the tool before it is used to fabricate and shape the part. However, it has been shown through glass transition temperature tests performed on specimen coupons taken from parts fabricated in this manner that even with suitable tool drying times and temperatures, a number of the ply layers adjacent to the tool still incur carbamate contamination.

### BRIEF DESCRIPTION OF THE DRAWINGS

FIG. 1 is an isometric view of a satellite including a deployed sun shield support structure;

FIG. 2 is an isometric view of a tool for fabricating an aft or forward panel that are part of the sun shield support structure on the satellite shown in FIG. 1;

FIG. 3 is a profile view of an assembly including a representation of the tool shown in FIG. 2, a number of fabrication and part layers on the tool, and a bagging film sealed to the tool;

FIG. 4 is a profile view of the part layers shown in FIG. 3;

FIG. 5 is the isometric view of the tool shown in FIG. 2 and including a moisture barrier thereon; and

FIG. 6 is the isometric view of the tool shown in FIG. 2 and including a wrinkle barrier thereon.

### DETAILED DESCRIPTION OF THE EMBODIMENTS

The following discussion of the embodiments of the invention directed to a method for fabricating a carbon fiber composite part that includes providing a moisture barrier and wrinkle barrier between a tool and the composite part during the fabrication process is merely exemplary in nature, and is in no way intended to limit the invention or its applications or uses. For example, the present invention has particular application for fabricating a carbon fiber composite part on a spacecraft. However, as will be appreciated by those skilled in the art, the fabrication technique discussed herein may have application for fabricating other types of parts.

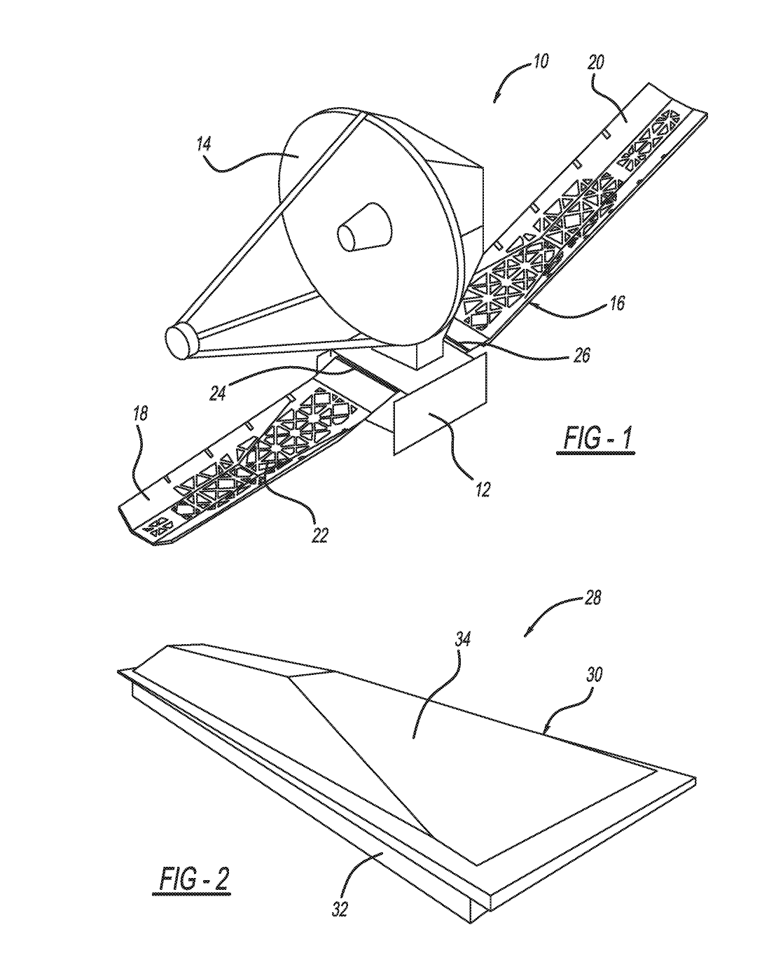

FIG. 1 is an isometric view of a spacecraft 10 including a spacecraft bus 12 and an optical telescope 14 mounted to the bus 12. A sun shield support structure 16 is also mounted to the spacecraft bus 12 in a foldable manner so that the structure 16 can be deployed to the position shown in FIG. 1 once on orbit. It is noted that the sun shield itself that is draped and supported on the sun shield support structure 16 is not shown for clarity purposes. The support structure 16 includes a forward panel 18 and an aft panel 20 positioned on opposite sides of the bus 12, as shown, and each being mounted to the bus 12 by a hinge structure 24 and 26, respectively. In this non-limiting embodiment, the forward panel 18 is about 2 meters wide and about 7.7 meters long and the aft panel 20 is about 2 meters wide and about 9 meters long. As shown, each of the forward panel 18 and the aft panel 20 includes a lattice structure 22 that reduces the weight of the spacecraft 10 without suffering significant loss of structural integrity.

The forward panel 18 and the aft panel 20 are required to be light weight for spacecraft applications and very rigid for properly deploying the sun shield. To provide these requirements, each of the forward panel 18 and the aft panel 20 may be fabricated by a carbon fiber composite fabrication process as a single piece of the type generally discussed above on a graphite composite tool.

FIG. 2 is an illustration 28 showing an isometric view of a tool 30 having the general shape of one of the panels 18 or 20, where the different layers ultimately forming the panel 18 or 20 and that are part of the fabrication process are layered on top of each other on the tool 30, then vacuumed sealed and baked in an autoclave or other type of oven (not shown) in a curing process for a suitable period of time and at a suitable temperature to provide the panel 18 or 20 having the stiffness, strength, rigidity, etc. for the particular application. In one non-limiting embodiment, the tool 30 is a carbon fiber/bismaleimide (BMI) composite. The tool 30 is shown supported on a suitable table 32 that can be wheeled into the autoclave, which is typically necessary because of the size and weight of the panel 18 or 20.

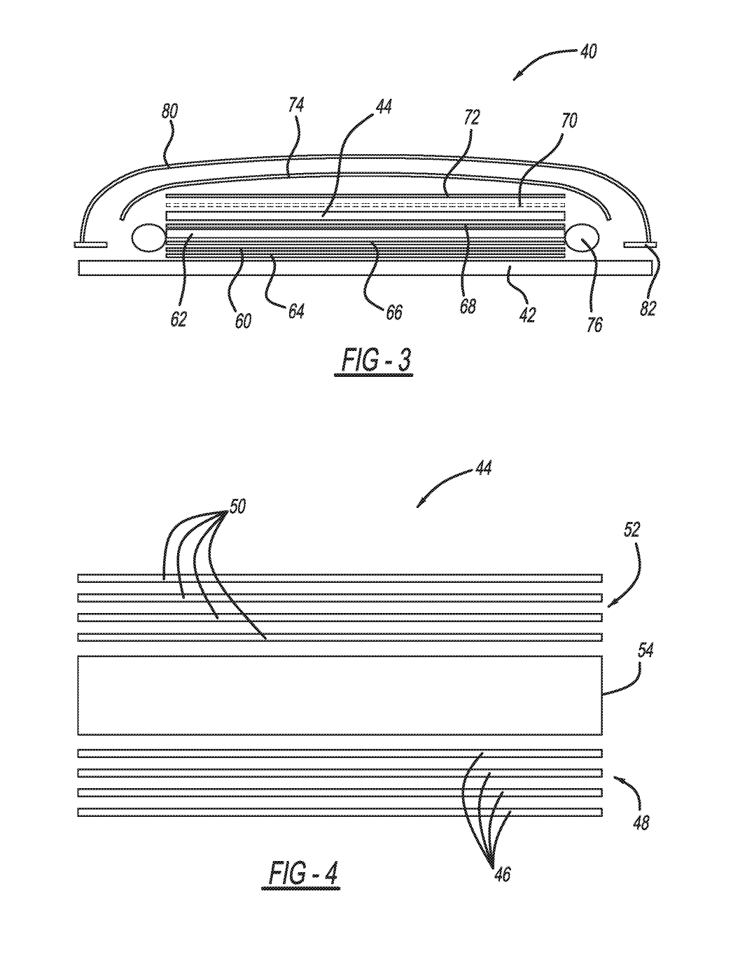

FIG. 3 is a profile view of a fabrication assembly 40 including a tool 42, representing the tool 30, and the various layers deposited thereon during the fabrication process and prior to the assembly 40 being placed into the autoclave for curing. The assembly 40 includes a part 44 that will ultimately be the panel 18 or 20 in this non-limiting example.

FIG. 4 is a profile view of the part 44 showing a general layer representation. The part 44 includes a number of carbon fiber ply layers 46 defining a tool-side face sheet 48 on the tool-side of the part 44 and a number of carbon fiber ply layers 50 defining a bag-side face sheet 52 on a bag-side of the part 44. In this non-limiting example, each of the face sheets 48 and 52 includes four of the ply layers 46 and 48, respectively. However, this is merely for illustration purposes in that the number of the ply layers would be application specific for the desired thickness, rigidity, strength, etc. of the part 44 and could be several more of the ply layers. A honeycomb structure 54 is formed between the face sheets 50 and 52 and includes a series of carbon fiber ply layers having openings and channels defining the honeycomb structure 54 that are laid on top of each to the desired thickness in a manner well understood by those skilled in the art.

According to the invention, the assembly 40 includes a moisture barrier 60 positioned between the tool 42 and the part 44 that prevents moisture from the tool 42 from entering the part 44 during the fabrication and curing process. The assembly 40 also includes a wrinkle barrier 62 positioned between the moisture barrier 60 and the part 44 to prevent wrinkles and anomalies in the moisture barrier 60 from being transferred to the adjacent ply layers 46 in the face sheet 48 of the part 44. Particularly, wrinkling in the moisture barrier 60 may cause deformations in the fibers in the first few ply layers 46 of the face sheet 48. If the fibers deform and wrinkle, they may be unable to properly carry the desired load, which could cause buckling of the part 44 and possibly breaking. The moisture barrier 60 and the wrinkle barrier 62 will be discussed in further detail below.

The assembly 40 also includes a 1-ply FEP layer 64 positioned between the tool 42 and the moisture barrier 60, a 1-ply FEP layer 66 positioned between the moisture barrier 60 and the wrinkle barrier 62, and a 1-ply FEP layer 68 positioned between the wrinkle barrier 62 and the part 44. The FEP layer 64 is shown as layer 34 on the tool 30 in FIG. 2. The FEP layers 64, 66 and 68 are polyester layers that are positioned between the various layers discussed herein so as to allow those layers to better slide on the tool 30 relative to each other during the assembly process so as to help prevent kinks and other anomalies on the various layers, where each ply is about 1 mil in thickness.

A porous armalon layer 70 is positioned on the part 44 to allow excess resin to flow out of the part 44 during the curing process in the autoclave. An FEP layer 72 is positioned on the armalon layer 70 and a breather layer 74 is provided over the FEP layer 72 to provide a consistent vacuum across the part 44. The assembly 40 also includes a boat cloth breather 76 positioned around the periphery of the layers, as shown, to also properly distribute the vacuum. The assembly 40 further includes an outer bagging film 80 that is sealed to the tool 42 by a tape layer 82, such as chromate tape, where the bagging film 80 is evacuated to generate a vacuum therein before the assembly 40 is placed in the autoclave for curing.

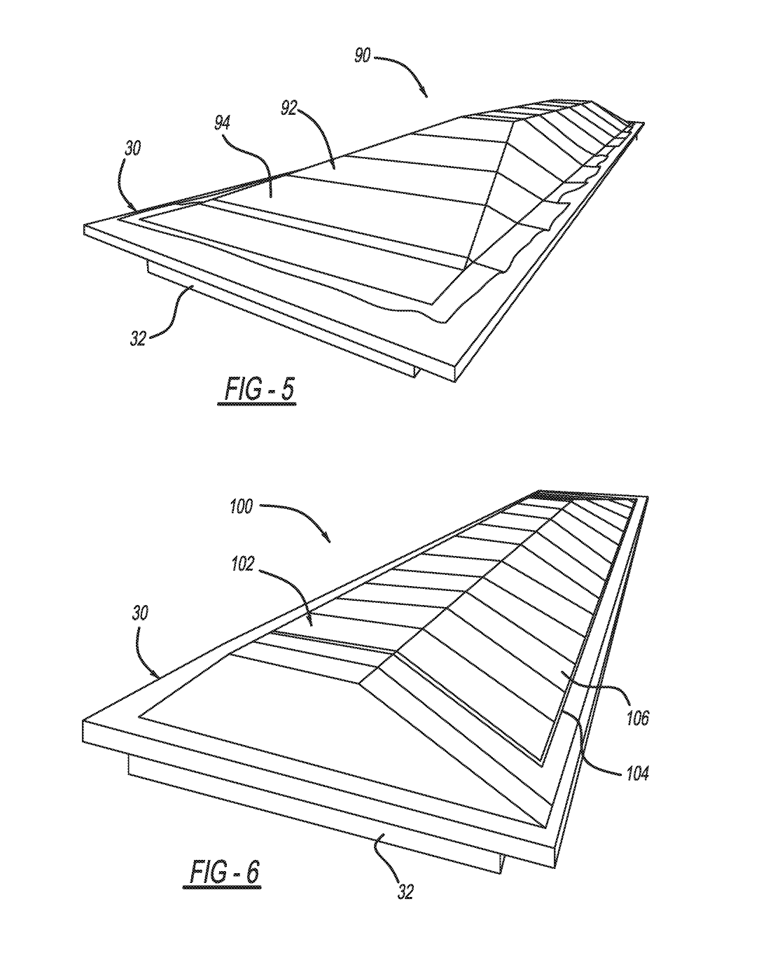

FIG. 5 is an illustration 90 also showing an isometric view of the tool 30 and illustrating a fabrication step of the panel 18 or 20, where a moisture barrier layer 92, representing the moisture barrier 70, is shown positioned on the tool 30 on top of the FEP layer 34, but before the FEP layer 66 has been laid down. In this embodiment, the moisture barrier layer 92 includes a number of strips 94 of aluminum foil that are laid cross-wise across the tool 30, where each of the strips 94 is about 12″ wide and each of the strips 94 overlaps an adjacent strip 94 by some predetermined amount, such as 2-3 inches, to accommodate thermal expansion differences between the foil strips 94 and the tool 30. Particularly, since the coefficient of thermal expansion (CTE) between the aluminum foil strips 94 and the graphite composite of the tool 30 are so different, where the strips 94 expand more than the tool 30 when heated, positioning the strips 94 in this manner allows the foil to expand without wrinkling or tearing. In one non-limiting embodiment, the moisture barrier layer 92 is 1 mil in thickness, and two of these foil layers are positioned on the tool 30 adjacent to each other, where the combined layers form a moisture barrier of about 2 mils thick. In one non-limiting embodiment, each of the two aluminum foil layers is a 0.008″ thick 6061-T6 aluminum caul sheet layer.

Once the barrier layer 60 and the ply layer 66 have been laid down on the tool 42, then the wrinkle barrier 62 is positioned on the tool 42. FIG. 6 is an illustration 100 also showing an isometric view of the tool 30 and illustrating a fabrication step of the panel 18 or 20, where a wrinkle barrier 102, representing the wrinkle barrier 62, is shown positioned on the tool 30, but before the FEP layer 68 has been positioned on the wrinkle barrier 62. It is noted that the illustration 100 also shows a chromate tape 104 extending around the perimeter of the tool 30, which ultimately will seal the bagging film 80 to the tool 30. In one non-limiting embodiment, the wrinkle barrier 102 is four ply layers of a carbon fiber composite, such as a M60J polycyanate resin, providing a total thickness of 9 mils. Also, in this embodiment, the wrinkle barrier 102 is laid down as strips 106 cross-wise on the tool 30, which provides assembly advantages because of the size of the part 44. As mentioned, the wrinkle barrier 102 prevents any wrinkles or other anomalies in the moisture barrier layer 92 as a result of the layer 92 expanding when heated, or otherwise.

Once the assembly 40 is cured in the autoclave for the predetermined period time, coupons from the assembly 40 are removed for testing and quality control purposes to ensure that the part 44 operates properly. If the part 44 is good, then the part 44 is removed from the assembly 40 to be provided to the spacecraft assembly process.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A method for fabricating a carbon fiber composite part, said method comprising:
providing a tool;
positioning a moisture barrier on the tool;
positioning a wrinkle barrier on the moisture barrier;
positioning a plurality of carbon fiber part ply layers on the wrinkle barrier, where the plurality of the part ply layers will ultimately be the part after the fabrication; and
curing the part ply layers so as to provide the part.

2. The method according to claim 1 wherein positioning a moisture barrier includes positioning at least one aluminum foil layer.

3. The method according to claim 2 wherein positioning at least one aluminum foil layer includes positioning two aluminum foil layers.

4. The method according to claim 3 wherein positioning two aluminum foil layers includes positioning two 0.008″ thick 6061-T6 aluminum caul sheet layers.

5. The method according to claim 2 wherein positioning at least one aluminum foil layer includes positioning strips of aluminum foil cross-wise across the tool in a manner so that adjacent foil strips overlap.

6. The method according to claim 5 wherein each adjacent foil strips overlap in the range of 2-3 inches.

7. The method according to claim 1 wherein positioning a wrinkle barrier includes positioning at least one carbon fiber composite layer.

8. The method according to claim 7 wherein positioning at least one carbon fiber composite layer includes positioning a plurality of M60J polycyanate resin layers.

9. The method according to claim 1 wherein positioning a wrinkle barrier includes positioning a wrinkle barrier to a thickness of about 9 mils.

10. The method according to claim 1 wherein positioning a wrinkle barrier includes positioning strips of wrinkle barrier material.

11. The method according to claim 1 further comprising positioning a first slip layer between the tool and the moisture barrier, positioning a second slip layer between the moisture barrier and the wrinkle barrier, and positioning a third slip layer between the wrinkle barrier and the part.

12. The method according to claim 11 wherein positioning the first, second and third slip layers includes positioning first, second and third polyester layers each having a thickness of about 1 mil.

13. The method according to claim 1 wherein positioning a plurality of carbon fiber part layers includes positioning a plurality of carbon fiber ply layers in a manner that defines a first face sheet that includes a plurality of ply layers, a second face sheet that includes a plurality of ply layers and a honeycomb structure therebetween.

14. The method according to claim 1 further comprising covering the part in a vacuum seal film prior to curing the part, and curing the part in an oven after it is vacuum sealed.

15. The method according to claim 1 wherein providing a tool includes providing a carbon fiber/bismaleimide (BMI) composite tool.

16. The method according to claim 1 wherein the part is a spacecraft part.

17. The method according to claim 16 wherein the spacecraft part is a panel for supporting a sun shield.

18. A method for fabricating a carbon fiber composite part, said method comprising:
providing a tool;
positioning a moisture barrier on the tool, wherein positioning a moisture barrier includes positioning strips of aluminum foil cross-wise across the tool in a manner so that adjacent foil strips overlap;
positioning a plurality of carbon fiber part ply layers on the moisture barrier, where the plurality of the part ply layers will ultimately be the part after the fabrication; and
curing the part ply layers so as to provide the part.

19. A method for fabricating a carbon fiber composite part, said method comprising:
providing a tool;
positioning a wrinkle barrier on the tool, wherein positioning a wrinkle barrier includes positioning at least one carbon fiber composite layer;
positioning a plurality of carbon fiber part ply layers on the wrinkle barrier, where the plurality of the part ply layers will ultimately be the part after the fabrication; and
curing the part ply layers so as to provide the part.

20. The method according to claim 19 wherein positioning a wrinkle barrier includes positioning carbon fiber composite strips.
